(19) United States
(12) Patent Application Publication
(10) Pub. No.: US 2022/0237510 A1
(43) Pub. Date: Jul. 28, 2022

(54) METHOD FOR TRAINING MULTIMEDIA RECOMMENDATION MODEL AND SERVER

(71) Applicant: BEIJING DAJIA INTERNET INFORMATION TECHNOLOGY CO., LTD., Beijing (CN)

(72) Inventors: Jixiang LI, Beijing (CN); Sen YANG, Beijing (CN); Jiyuan JIA, Beijing (CN)

(21) Appl. No.: 17/475,813

(22) Filed: Sep. 15, 2021

(30) Foreign Application Priority Data
Jan. 28, 2021 (CN) 202110120344.6

(51) Int. Cl. G06N 20/00; G06F 9/451

(52) U.S. Cl. CPC G06N 20/00; G06F 9/451

(57) ABSTRACT

A method for training a multimedia recommendation model is provided. The method includes: iteratively training a plurality of multimedia recommendation models with the same model structure; determining, based on a first association model determined at an i^{th} model determination of a first multimedia recommendation model, a second association model corresponding to the first multimedia recommendation model determined at a (i+1)^{th} model determination; and determining, based on model parameters of the first multimedia recommendation model and the second association model, a target model parameter of the first multimedia recommendation model, wherein the model parameter of each of the plurality of multimedia recommendation models is a weight parameter.

### CROSS-REFERENCE TO RELATED APPLICATION

This disclosure is based on and claims priority to Chinese Patent Application No. 202110120344.6, filed on Jan. 28, 2021, the disclosure of which is herein incorporated by reference in its entirety.

### TECHNICAL FIELD

The present disclosure relates to the field of deep learning technologies, and in particular, relates to a method for training a multimedia recommendation model and a server.

### BACKGROUND

With advancements, of deep learning technologies, deep learning has replaced traditional machine learning algorithms and has become the first choice in machine leaning. An essence of the deep learning is to build a machine learning model with many hidden layers and to train the model with masses of training data, such that the model learns more useful features, thereby improving output accuracy of the model.

At present, the deep learning has been widely used in the field of multimedia recommendation.

### SUMMARY

According to a first aspect of the present disclosure, a method for training a multimedia recommendation model is provided. The method includes:

iteratively training a plurality of multimedia recommendation models, wherein model structures of the plurality of multimedia recommendation models are the same, and a model parameter of each of the plurality of multimedia recommendation models is a weight parameter; determining, based on a first association model corresponding to a first multimedia recommendation model, a second association model corresponding to the first multimedia recommendation model, wherein the first association model is an association model determined at an i^{th} model determination, and the second association model is an association model determined at a (i+1)^{th} model determination, where i is a positive integer, the first multimedia recommendation model is any one of the plurality of multimedia recommendation models, each of the first association model and the second association model is one of the plurality of multimedia recommendation models excluding the first multimedia recommendation model, and the first association model is different from the second association model; and determining, based on the model parameter of the first multimedia recommendation model and the model parameter of the second association model, a target model parameter of the first multimedia recommendation model.

According to a second aspect of the embodiments of the present disclosure, a server is provided. The server includes: one or more processors; and a memory configured to store at least one program code executable by the one or more processors; wherein the one or more processors, when loading and executing the at least one program code, are caused to perform: iteratively training a plurality of multimedia recommendation models, wherein model structures of the plurality of multimedia recommendation models are the same, and a model parameter of each of the plurality of multimedia recommendation models is a weight parameter; determining, based on a first association model corresponding to a first multimedia recommendation model, a second association model corresponding to the first multimedia recommendation model, wherein the first association model is an association model determined at an i^{th} model determination, and the second association model is an association model determined at a (i+1)^{th} model determination, where i is a positive integer, the first multimedia recommendation model is any one of the plurality of multimedia recommendation models, each of the first association model and the second association model is one of the plurality of multimedia recommendation models excluding the first multimedia recommendation model, and the first association model is different from the second association model; and determining, based on the model parameter of the first multimedia recommendation model and the model parameter of the second association model, a target model parameter of the first multimedia recommendation model.

According to a third aspect of the embodiments of the present disclosure, a non-transitory computer-readable storage medium including at least one program code therein is provided. The at least one program code, when loaded and executed by a processor of a server, causes the server to perform: iteratively training a plurality of multimedia recommendation models, wherein model structures of the plurality of multimedia recommendation models are the same, and a model parameter of each of the plurality of multimedia recommendation models is a weight parameter; determining, based on a first association model corresponding to a first multimedia recommendation model, a second association model corresponding to the first multimedia recommendation model, wherein the first association model is an association model determined at an i^{th} model determination, and the second association model is an association model determined at a (i+1)^{th} model determination, where i is a positive integer, the first multimedia recommendation model is any one of the plurality of multimedia recommendation models, each of the first association model and the second association model is one of the plurality of multimedia recommendation models excluding the first multimedia recommendation model, and the first association model is different from the second association model; and determining, based on the model parameter of the first multimedia recommendation model and the model parameter of the second association model, a target model parameter of the first multimedia recommendation model.

### BRIEF DESCRIPTION OF THE DRAWINGS

FIG. 1 is a schematic diagram of an implementation environment of a method for training a multimedia recommendation model according to an exemplary embodiment of the present disclosure;

FIG. 2 is a flowchart of a method for training a multimedia recommendation model according to an exemplary embodiment of the present disclosure;

FIG. 3 is a flowchart of a method for training a multimedia recommendation model according to an exemplary embodiment of the present disclosure;

FIG. 4 is a schematic diagram of a framework of a multimedia recommendation model according to an exemplary embodiment of the present disclosure;

FIG. 5 is a schematic diagram of determining an association model according to an exemplary embodiment of the present disclosure;

FIG. 6 is another schematic diagram of determining an association model according to an exemplary embodiment of the present disclosure;

FIG. 7 is a block diagram of an apparatus for training a multimedia commendation model according to an exemplary embodiment of the present disclosure; and

FIG. 8 is a block diagram of a server according to an exemplary embodiment of the present disclosure.

### DETAILED DESCRIPTION

Data involved in the present disclosure is authorized by a user or fully authorized by each party.

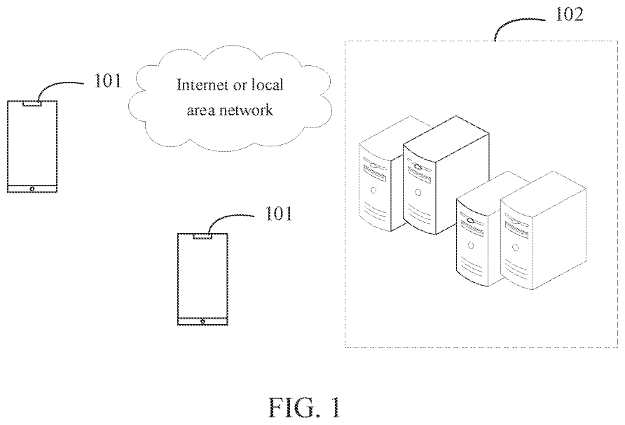

FIG. 1 is a schematic diagram of an implementation environment of a method for training a multimedia recommendation model according to an exemplary embodiment of the present disclosure, Referring to FIG. 1, the implementation environment includes: a terminal 101 and a server 102.

The terminal 101 includes at least one of a smart phone, a smart watch, a desktop computer, a laptop computer, a virtual reality terminal, an augmented reality terminal, a wireless terminal, a laptop portable computer, and other devices. The terminal 101 has a communication function and can access the Internet. The terminal 101 generally refers to one of a plurality of terminals, and in embodiments of the disclosure, the terminal 101 is used as an example for illustration. Those skilled in the art may know that, in some other embodiments, the number of terminals may be more or less. In some embodiments of the present disclosure, the terminal 101 is configured to send online data to the server 102, so as to trigger the server 102 to iteratively train a plurality of multimedia recommendation models based on the online data. The online data is online data sent by an operation of the user based on a multimedia resource. In some embodiments, the online data includes account information, interactive behavior information or multimedia resource information, and the like of the user. For example, the interactive behavior information includes a like behavior, a comment behavior, or a sharing behavior, and the multimedia resource information includes video content, video play information, etc.

The server 102 is an independent physical server, or a server cluster composed of a plurality of physical servers or a distributed file system, or a cloud server providing a cloud service, a cloud database, cloud computing, a cloud function, cloud storage, a network service, cloud communication, a middleware service, a domain name service, a security service, a content delivery network (CDN), and big data and an artificial intelligence platform and other basic cloud computing services. The server 102 and the terminal 101 are directly or indirectly connected by means of wired or wireless communication, which is not limited in embodiments of the present disclosure. In some embodiments, the number of the servers 102 may be more or less, which is not limited. In some other embodiments, the server 102 also includes other functional servers to provide more comprehensive and diversified services. In embodiments of the present disclosure, the server 102 is configured to iteratively train a plurality of multimedia recommendation models to determine an association model corresponding to each multimedia recommendation model, and then determine, based on a model parameter of each multimedia recommendation model and a model parameter of the corresponding association model, a target model parameter of each multimedia recommendation model.

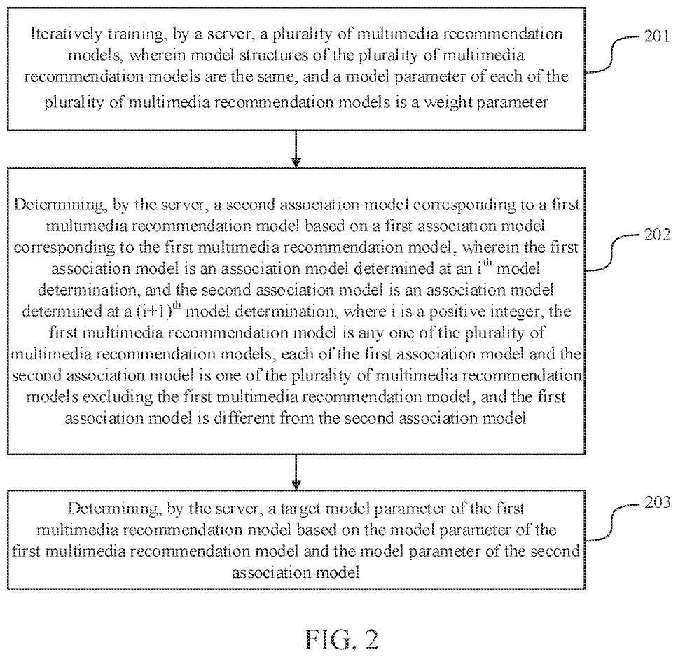

FIG. 2 is a flowchart of a method for training a multimedia recommendation model according to an exemplary embodiment of the present disclosure. As shown in FIG. 2, the method is applicable to a server and includes the followings.

In S201, the server iteratively trains a plurality of multimedia recommendation models, wherein model structures of the plurality of multimedia recommendation models are the same, and a model parameter of each of the plurality of multimedia recommendation models is a weight parameter.

In S202, the server determines a second association model corresponding to a first multimedia recommendation model based on a first association model corresponding to the first multimedia recommendation model. The first association model is an association model determined at an i^{th} model determination, and the second association model is an association model determined at a (i+1)^{th} model determination, where i is a positive integer. The first multimedia recommendation model is any one of the plurality of multimedia recommendation models. Each of the first association model and the second association model is one of the plurality of multimedia recommendation models excluding the first multimedia recommendation model, and the first association model is different from the second association model.

In S203, the server determines a target model parameter of the first multimedia recommendation model based on the model parameter of the first multimedia recommendation model and the model parameter of the second association model.

In the technical solution according to embodiments of the present disclosure, every time when the association model determined for each multimedia recommendation model is determined, it is based on the association model determined last time. Therefore, the model parameters of the various multimedia recommendation models can be combined and interacted as much as possible, parameter optimization among the multimedia recommendation models can be performed more extensively, and the comprehensiveness of model training is improved, which improves a prediction capability of the multimedia recommendation model.

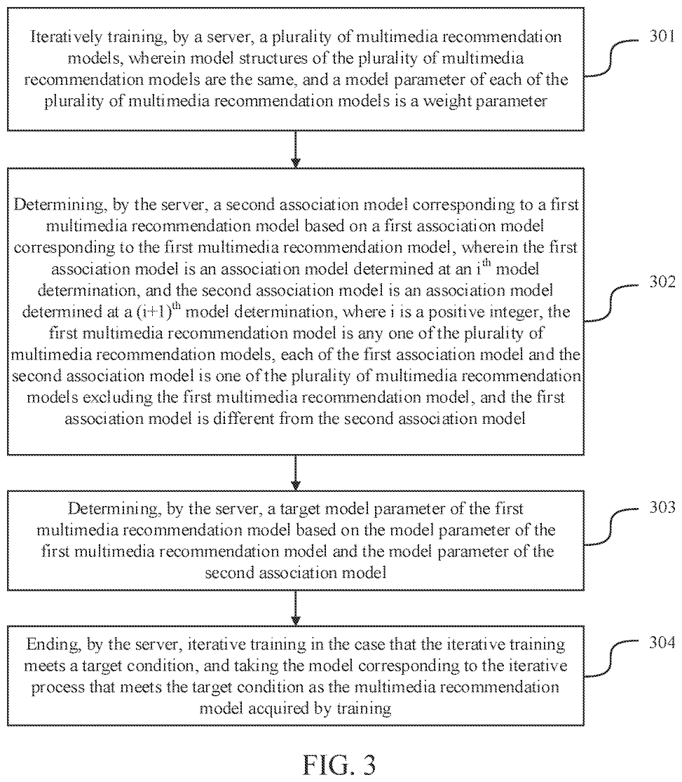

FIG. 2 shows only a basic process of the method for training the multimedia recommendation model according to the present disclosure. The solution according to the present disclosure is further explained based on specific practice hereinafter. FIG. 3 is a flowchart of a method for training a multimedia recommendation model according to an exemplary embodiment of the present disclosure. Referring to FIG. 3, this embodiment uses the interaction between a terminal and a server as an example to illustrate the solution, including the followings.

In S301, the server iteratively trains a plurality of multimedia recommendation models, wherein model structures of the plurality of multimedia recommendation models are the same, and a model parameter of each of the plurality of multimedia recommendation models is a weight parameter.

In embodiments of the present disclosure, the model structures of the plurality of multimedia recommendation models are the same, that is, hierarchical structures such as input layers, embedding layers, and fully connected layers of the plurality of multimedia recommendation models are the same, and the model parameters of the plurality of multimedia recommendation models are of the same type, that is, are all weight parameters. In this way, since the model structures of the plurality of multimedia recommendation models are the same, the plurality of multimedia recommendation models have a basis for mutual reference. Meanwhile, since the model parameters of the plurality of multimedia recommendation models are all weight parameters, the model parameters of the plurality of multimedia recommendation models also have a basis for mutual reference, which facilitates a subsequent combination process of the model parameters. The model parameter (that is, the weight parameter) may characterize a model function. It should be understood that the process of model training is also a process of optimizing each model parameter in the model.

In some embodiments, in the case that the server acquires training data, during each iteration training, the server shuffles training samples in the training data to acquire the training samples of each multimedia recommendation model in the current iteration. Then, based on the training samples of each multimedia recommendation model in the current iteration, each multimedia recommendation model is iteratively trained.

Since the training samples in the training data are shuffled, the training data of the plurality of multimedia recommendation models in each iteration may be the same or different. For example, in the case that the training data includes 15 training samples, which are 1-15 respectively, the multimedia recommendation models include 3 models, and for example, 5 samples are input for each iteration, then in one iteration training process, after data shuffling, the training samples of model 1 in the current iteration include [1, 3, 2, 6, 5], the training samples of model 2 in the current iteration include [5, 4, 3, 2, 1], and the training samples of model 3 in the current iteration include [9, 15, 12, 14, 13].

In some embodiments, the server iteratively trains the plurality of multimedia recommendation models based on offline training data, wherein the offline training data refers to the training data well prepared before the implementation of this solution.

In some embodiments, the server iteratively trains the plurality of multimedia recommendation models based on online training data, wherein the online training data is data sent by the terminal to the server in response to a click operation of the user. The corresponding process is that the server receives the online data sent by the terminal, and iteratively trains, based on the online data, the plurality of multimedia recommendation models.

The process of iterative training is described hereinafter:

In response to acquiring the training data, the server extracts a plurality of training samples in the training data and sample labels corresponding to the plurality of training samples, and acquires a training result of the current iteration by inputting the plurality of training samples into the plurality of multimedia recommendation models respectively in one iteration. The model parameters of the plurality of multimedia recommendation models are updated based on the training result of the current iteration and the sample labels, and the model parameters of the plurality of multimedia recommendation models upon completion of the current iteration are acquired.

In some embodiments, in one iteration, the process of outputting the training result of the current iteration is that, for any multimedia recommendation model, the server inputs the training samples into the multimedia recommendation model, and acquires a plurality of sample features of the training samples by extracting features from the training samples by a feature extraction layer of the multimedia recommendation model, Then a target sample feature is acquired by combining the plurality of sample features, the target sample feature is input into the fully connected layer of the plurality of multimedia recommendation models, and then the training result of the current iteration is output.

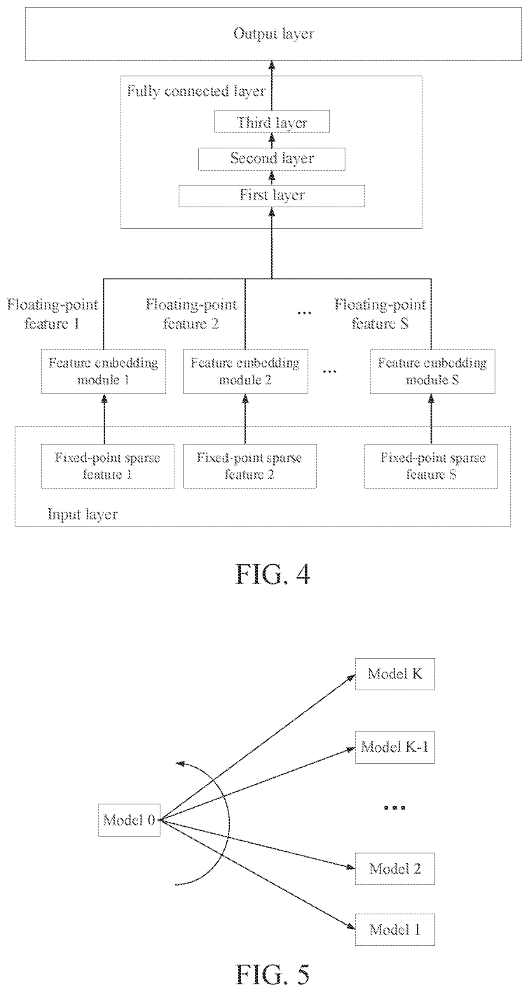

FIG. 4 is a schematic diagram of a framework of a multimedia recommendation model according to an exemplary embodiment of the present disclosure. Referring to FIG. 4, for any multimedia recommendation model, the multimedia recommendation model includes an input module, a feature embedding module, a fully connected layer module and an output. module. The feature extraction layer mentioned above may be the feature embedding module shown in FIG. 4. Correspondingly, the process of outputting the training result of the current iteration is that, in the case that the server acquires the training samples, the server inputs the training samples into the multimedia recommendation model, the multimedia recommendation model analyzes the training samples to acquire S fixed-point sparse features, that is, fixed-point sparse feature 1 to fixed-point sparse feature S shown in FIG. 4. The acquired S fixed-point sparse features are respectively input into the corresponding feature embedding module, the S fixed-point sparse features are converted into S floating-point features through respective feature embedding modules, and then the S floating-point features are combined to realize the merging of the S floating-point features. Therefore, the merged floating-point feature is input into the fully connected layer module of the multimedia recommendation model, and prediction is performed based on the floating-point feature through the fully connected layer module to output a prediction vector.

In some embodiments, the process of updating the model parameter by the server is that in one iteration, based on the training result and the sample label of the current iteration, a loss value between the training result and the sample label is calculated, and the model parameter in the multimedia recommendation model is updated by using the calculated loss value and a gradient back propagation algorithm. The gradient back propagation algorithm is a model parameter update algorithm based on the principle of minimizing a loss function.

In S302, the server determines a second association model corresponding to a first multimedia recommendation model based on a first association model corresponding to the first multimedia recommendation model. The first association model is an association model determined at an i^{th} model determination, and the second association model is an association model determined at a (i+1)^{th} model determination, where i is a positive integer. The first multimedia recommendation model is any one of the plurality of multimedia recommendation models, each of the first association model and the second association model is one of the plurality of multimedia recommendation models excluding the first multimedia recommendation model, and the first association model is different from the second association model.

In some embodiments, upon completion of an iteration, an initial association model of the first multimedia recommendation model is selected from the plurality of multimedia recommendation models excluding the first multimedia recommendation model. Upon completion of a N^{th} iteration, a next multimedia recommendation model adjacent to the first association model is determined as the second association model corresponding to the first multimedia recommendation model, where N is a number of iterations of model training, and N is a positive integer greater than 1. The initial association models corresponding to the multimedia recommendation models are different.

The initial association model refers to the association model determined for the first time. In embodiments of the present disclosure, the initial association models corresponding to the multimedia recommendation models are different. In this way, respective multimedia recommendation models can be combined and interacted with different association models, parameter optimization among the multimedia recommendation models can be more extensively performed, and the comprehensiveness of parameter optimization can be improved.

In embodiments of the present disclosure, the initial association model of the first. multimedia recommendation model may be any one of the plurality of multimedia recommendation models excluding the first multimedia recommendation model. In some other embodiments, the initial association model of the first multimedia recommendation model is a model adjacent to the first multimedia recommendation model, for example, the previous model of the first multimedia recommendation model, or the next model of the first multimedia recommendation model.

In embodiments of the present disclosure, the server may determine the initial association model corresponding to the first multimedia recommendation model upon completion of any iteration, for example, upon completion of the first iteration, or the third iteration. In embodiments of the present disclosure, when to determine the initial association model is not limited. In the following description, determining the initial association model upon completion of the first iteration is taken as an example.

In some embodiments, the server determines the second association model corresponding to the first multimedia recommendation model based on a serial number of the first multimedia recommendation model. That is, upon completion of the N^{th} iteration, the server determines, based on the serial number of the first association model determined for the first multimedia recommendation model upon completion of the (N−1)^{th} iteration, the multimedia recommendation model corresponding to the next serial number as the second association model corresponding to the first multimedia recommendation model upon completion of the N^{th} iteration.

In some embodiments, the server triggers the execution of the process of determining the association model upon completion of each iteration. For example, upon completion of the first iteration, the server takes the next model of the first multimedia recommendation model as the first association model (that is, the initial association model) of the first multimedia recommendation model; upon completion of the second iteration, based on the serial number of the first association model, the server determines the multimedia recommendation model corresponding to the next number as the association model of the first multimedia recommendation model upon completion of the second iteration; and upon completion of a N^{th} iteration, based on the serial number of the association model upon completion of a (N−1)^{th} iteration, the server determines the multimedia recommendation model corresponding to the serial number next to the serial number of the association model upon completion of the (N−1)^{th} iteration, as the association model of the first multimedia. recommendation model upon completion of the N^{th} iteration.

In the above process, a different initial association model is set for each multimedia recommendation model, and then based on different initial association models, the next model is determined in turn as the association model. In this way, the association model determined upon completion of each iteration is different from the association model determined upon completion of the previous iteration, and the association models determined for the multimedia recommendation model upon completion of each iteration are different, thereby further improving the reference and combination among the models, and performing parameter optimization among the multimedia recommendation models more extensively.

The above example is illustrated by taking the process of determining the association model upon completion of each iteration as an example. In some other embodiments, the server may also set a moment of determining the association model.

In some embodiments, the server performs iterative training on the first multimedia recommendation model, and the server determines the second association model corresponding to the first multimedia recommendation model based on the first association model corresponding to the first multimedia recommendation model at an interval of a target number of iterations and upon completion of the current iteration. Exemplarily, by taking M as an example of the target number of iterations, and by taking the initial association model being determined upon completion of the first iteration as an example, the server determines the association models corresponding to the first multimedia recommendation model upon completion of the (M+1)^{th} iteration, the (2M+1)^{th} iteration, the (3M+1)^{th} iteration, and so on, which are different front each other and are all different from the initial association model, where M is a positive integer greater than . The target number may be preset and fixed, for example, 50. It should be understood that the number of iterations is also that the number of training steps.

In some other embodiments, the server iteratively trains the first multimedia recommendation model and determines the second association model corresponding to the first multimedia recommendation model based on the first association model corresponding to the first multimedia recommendation model at an interval of a target period and upon completion of the current iteration. The target period may be preset and fixed, for example, 0.2 hour.

In the above process, at an interval of a certain number of iterations or a certain period, for each multimedia recommendation model, the association model corresponding to each multimedia recommendation model is determined according to the above method, and the model parameters are optimized, such that the model parameters of the respective multimedia recommendation models can be combined and interacted as much as possible, and the model training is more comprehensive and efficient, thereby improving a prediction capability of the multimedia recommendation model.

In some other embodiments, the server may also determine a moment of executing the process of determining the association model and the target model parameter based on the training data. The specific implementation is as follows.

In some embodiments, in the case that the training data is offline training data, the association model and the target model parameter are determined at an interval of a target. number of iterations, Since the number of samples of discrete training data has been fixed, by determining the association model and the target model parameter according to a fixed number of iterations, it can be ensured that the number of samples during training of each model is consistent.

In some other embodiments, in the case that the training data is online training data, the association model and the target model parameter are determined at an interval of a target time length or at an interval of a target number of iterations. Since the moment when the server acquires the online training data is uncertain, based on multiple times of model training, it can be known that both the interval of the target period and the interval of the target number of iterations can ensure a consistent number of training samples of each multimedia recommendation model in one training process.

It could be understood that, the number of multimedia recommendation models is limited. Therefore, in the case that the first multimedia recommendation model has traversed the plurality of multimedia recommendation models excluding itself, loop traversal may also be continued according to the determined association models. In some embodiments, in the case that K-1 association models of the first multimedia recommendation model has been determined, the initial association model of the first multimedia recommendation model is selected as the association model of the first multimedia recommendation model upon completion of the current iteration, where K represents the number of the plurality of multimedia recommendation models, and is a positive integer greater than 1. That is, in the process of determining the association model of the first multimedia recommendation model, in the case that the plurality of multimedia recommendation models have been traversed once, the server continues the loop traversal on the plurality of multimedia recommendation models upon completion of the next iteration. Through the process of loop traversal, each multimedia recommendation model is combined and interacted with other multimedia recommendation models again, thereby combining the model parameters more extensively. Besides, the association model is determined through the loop traversal, which can quickly determine the association model of the next loop and improves the efficiency of determining the association model.

FIG. 5 is a schematic diagram of determining an association model according to an exemplary embodiment of the present disclosure. Referring to FIG. 5, K+1 multimedia recommendation models, namely a model 0, a model 1 . . . and a model K+1, are taken as an example. By taking the process of triggering the determination of the association model upon completion of each iteration as an example, for the model 0, upon completion of the first iteration, the next model (that is, the model 1) of the model 0 is taken as the initial association model, upon completion of the second iteration, the next model (that is, model 2) of the model 1 is taken as the association model, and so on. Upon completion of a K^{th} iteration, the model K is taken as the association model, and upon completion of a (K+1)^{th} iteration, the model 1 is reselected as the association model, and upon completion of a (K+2)^{th} iteration, the model 2 is reselected as the association model.

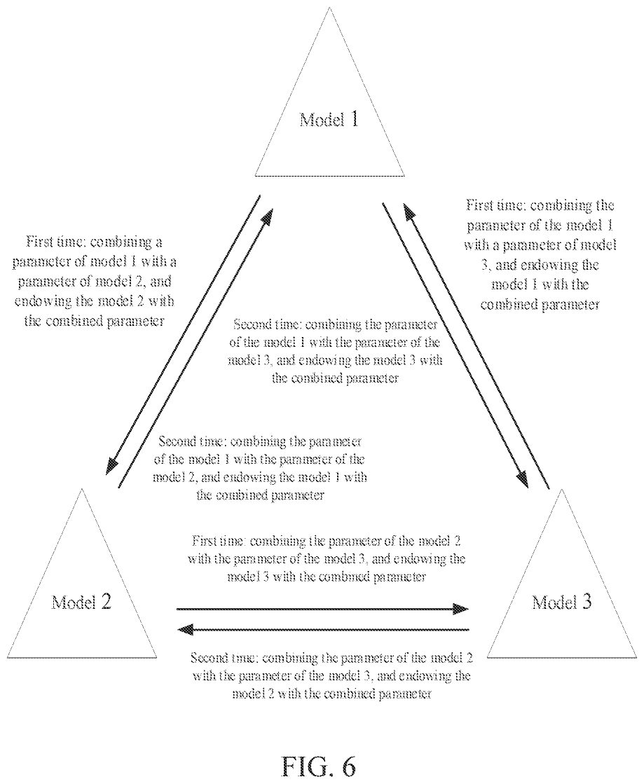

In the process of determining the association model of the first multimedia. recommendation model, the server skips the first multimedia recommendation model. For example, FIG. 6 is another schematic diagram of determining an association model according to an exemplary embodiment. Referring to FIG. 6. FIG. 6 takes three multimedia recommendation models, namely a model 1, a model 2, and a model 3, as an example and takes the previous model of the multimedia recommendation model as an example of the initial association model of the multimedia recommendation model. Upon completion of the first iteration, the initial association model of the model 1 is the model 3, the initial association model of the model 2 is the model 1, and the initial association model of the model 3 is the model 2; and upon completion of the second iteration, the association model of the model 1 is the model 2, the association model of the model 2 is the model 3, the association model of the model 3 is the model 1, and so on.

In S303, the server determines a target model parameter of the first multimedia recommendation model based on the model parameter of the first multimedia recommendation model and the model parameter of the second association model.

In some embodiments, based on a first weight coefficient of the first multimedia recommendation model and a second weight coefficient of the second association model, the target model parameter of the first multimedia recommendation model is determined by determining a weighted average of the model parameter of the first multimedia. recommendation model and the model parameter of the second association model.

In some embodiments, based on the first weight coefficient of the first multimedia recommendation model, the second weight coefficient of the second association model, and following Formula (1), the target model parameter of the first multimedia recommendation model is acquired by determining the weighted average of the model parameter of the first multimedia recommendation model and the model parameter of the second association model.

avg_param=(1−a)* model_2_param+a* model_1_param (1)

In this formula, avg _param represents the target model parameter of the first multimedia recommendation model, (1−a) represents the first weight coefficient of the first multimedia recommendation model, model_2_param represents the model parameter of the first multimedia recommendation model, a represents the second weight coefficient of the second association model and model_1_param represents the model parameter of the second association model.

In the above process, the two model parameters can be better combined by setting the first weight coefficient and the second weight coefficient, thereby improving the accuracy of optimizing the model parameters.

In some embodiments, referring to FIG. 6, upon completion of the first iteration, for the model 1, the initial association model of the model 1 is the model 3, then the model parameters of the model 1 and the model 3 are weighted averaged, and the acquired model parameter is taken as the target model parameter of the model 1; for the model 2, the initial association model of the model :2 is the model 1, then the model parameters of the model 1 and the model 2 are weighted averaged, and the acquired model parameter is taken as the target model parameter of the model 2; and for the model 3, the initial association model of the model 3 is the model 2, then the model parameters of the model 2 and the model 3 are subjected to weighted averaged, and the acquired model parameter is taken as the target model parameter of the model 3. Upon completion of the second iteration, for the model 1, the association model of the model 1 is the model 2, then the model parameters of the model 1 and the model 2 are weighted averaged, and the acquired model parameter is taken as the target model parameter of the model 1; for the model 2, the association model of the model 2 is the model 3, then the model parameters of the model 2 and the model 3 are weighted averaged, and the acquired model parameter is taken as the target model parameter of the model 2; for the model 3, the association model of model the 3 is the model 1, then the model parameters of the model 1 and the model 3 are weighted averaged, and the acquired model parameter is taken as the target model parameter of the model 3; and the like.

In some embodiments, the first weight coefficient and the second weight coefficient of the first multimedia recommendation model are determined based on the number of iterations of model training. In this process, the server adjusts the first weight coefficient and the second weight coefficient according to the progress of model training. The implementation is as follows.

(1) In the case that the number of iterations of model training is less than or equal to a first threshold, the server adjusts the first weight coefficient to a first value, and adjusts the second weight coefficient to a second value. The first value is greater than the second value.

The first threshold is a preset fixed threshold, and the number of iterations being less than or equal to the first threshold indicates an initial stage of model training. The first value and the second value are preset fixed values. For example, the first value is 0.95 and the second value is 0.05. Since the model parameters are initialized randomly, the model parameters of the plurality of multimedia recommendation models differ greatly in the initial stage of model training. Therefore, by maintaining the second weight coefficient at a low value in the initial stage of model training, the target model parameter in Formula (1) is mainly determined by the model parameter of the first multimedia recommendation model, that is, the target model parameter at the initial stage of model training is mainly determined by a weight of the model per se, which can ensure appropriate combination of the model parameters among the models while ensuring the stability of model training at the initial stage.

(2) In the case that the number of iterations of model training is greater than the first threshold and less than or equal to a second threshold, the server determines a value, of the second weight coefficient based on the number of iterations, and determines a value of the first weight coefficient based on the value of the second weight coefficient. The value of the second weight coefficient is positively correlated with the number of iterations.

The second threshold is a preset fixed threshold, and the number of iterations being greater than the first threshold and less than or equal to the second threshold indicates a middle stage of model training.

In some embodiments, the server determines the value of the second weight coefficient as follows. In response to the number of iterations of model training being greater than the first threshold and less than or equal to the second threshold, the server determines the value of the second weight coefficient based on the number of iterations and linear relationship data, in which the linear relationship data is relationship data in which the value of the second weight coefficient linearly increases with the number of iterations. In some embodiments, the second weight coefficient (that is, a) increases linearly with the increase of the number of iterations, such that at the middle stage of model training, the contribution of the model parameter of the association model to the target model parameter gradually increases, which can better achieve the optimization of the model parameter.

In some embodiments, in response to determining the second weight coefficient (that is, a), the server determines a result of (1−a) as the first weight coefficient.

(3) In the case that the number of iterations of model training is greater than the second threshold, the server adjusts both the first weight coefficient and the second weight coefficient to a third value.

The number of iterations being greater than the second threshold indicates a later stage of model training. Both the first weight coefficient and the second weight coefficient are adjusted to the third value, that is, the first weight coefficient and the second weight coefficient are adjusted to the same value of 0.5.

In this embodiment, in the later stage of model training, each multimedia recommendation model has been trained with a large number of training samples, and a change of the model parameter is relatively small. Therefore, the weight coefficient is set at about 0.5 at this time, and the contributions of the first multimedia recommendation model and the second association model to the target model parameter are the same, such that the target model parameter can be generated snore equally by the first multimedia recommendation model and the association model.

In S304, in the case that the iterative training meets a target condition, the server ends the iterative training and uses the model corresponding to the iterative process that meets the target condition as the multimedia recommendation model acquired by training.

In some embodiments, in the case that the training data for model training is all traversed, the server ends the iterative training, or in the case that the number of iterations of model training is greater than a target threshold, the server ends the iterative training, or in the case that the plurality of multimedia recommendation models all meet a convergence condition, the server ends the iterative training. Further, the model corresponding to the iterative process that meets the target condition is taken as the multimedia recommendation model acquired by training. It should be understood that through parallel training of the plurality of multimedia recommendation models and updating of the model parameters among the respective multimedia recommendation models, a plurality of trained multimedia. recommendation models can be acquired.

In the technical solution according to the embodiments of the present disclosure, every time when the association model determined for each multimedia recommendation model is determined, it is based on the association model determined last time. Therefore, the model parameters of the various multimedia recommendation models can be combined and interacted as much as possible, parameter optimization among the multimedia recommendation models can be performed more extensively, and the comprehensiveness of model training is improved, which improves a prediction capability of the multimedia recommendation model.

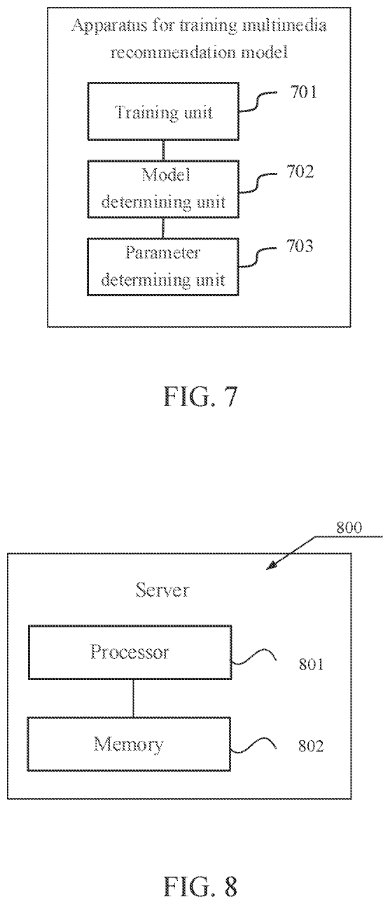

FIG. 7 is a block diagram of an apparatus for training a multimedia recommendation model according to an exemplary embodiment of the present disclosure. Referring to FIG. 7, the apparatus includes a training unit 701, a model determining unit 702, and a parameter determining unit 703.

The training unit 701 is configured to iteratively train a plurality of multimedia recommendation models, wherein model structures of the plurality of multimedia recommendation models are the same, and a model parameter of each of the plurality of multimedia recommendation models is a weight parameter.

The model determining unit 702 is configured to determine, based on a first association model corresponding to a first multimedia recommendation model, a second association model corresponding to the first multimedia recommendation model, wherein the first association model is an association model determined at an i^{th} model determination, and the second association model is an association model determined at a (i+1)^{th} model determination, where i is a positive integer, the first multimedia recommendation model is any one of the plurality of multimedia recommendation models, each of the first association model and the second association model is one of the plurality of multimedia recommendation models excluding the first multimedia recommendation model, and the first association model is different from the second association model.

The parameter determining unit 703 is configured to determine, based on the model parameter of the first multimedia recommendation model and the model parameter of the second association model, a target model parameter of the first multimedia recommendation model.

In some embodiments, the model determining unit 702 is configured to select, upon a completion of an iteration, an initial association model of the first multimedia recommendation model from the plurality of multimedia recommendation models excluding the first multimedia recommendation model, wherein each of the plurality of multimedia recommendation models is corresponding to a different initial association model; and determine, upon completion of a N^{th} iteration, a next multimedia recommendation model adjacent to the first association model, as the second association model corresponding to the first multimedia recommendation model, where N is a number of iterations of model training, and N is a positive integer greater than 1.

In some embodiments, the model determining unit 702 is further configured to, in response to K−1 association models of the first multimedia recommendation model having been determined, select the initial association model of the first multimedia recommendation model as the association model of the first multimedia recommendation model upon completion of a current iteration; wherein K is a number of the plurality of multimedia recommendation models, and K is a positive integer greater than 1.

In some embodiments, the parameter determining unit 703 is configured to determine the target model parameter of the first multimedia recommendation model by determining a weighted average of the model parameter of the first multimedia recommendation model and the model parameter of the second association model based on a first weight coefficient of the first multimedia recommendation model and a second weight coefficient of the second association model.

In some embodiments, the apparatus further includes a weight coefficient determining unit, configured to determine, based on a number of iterations of model training, the first weight coefficient and the second weight coefficient.

In some embodiments, the weight coefficient determining unit includes:

a first adjusting subunit, configured to, in response to the number of iterations of model training being less than or equal to a first threshold, adjust the first weight coefficient to a first value, and adjust the second weight coefficient to a second value, wherein the first value is greater than the second value;

a second adjusting subunit, configured to, in response to the number of iterations of model training being greater than the first threshold and less than or equal to a second threshold, determine a value of the second weight coefficient based on the number of iterations, and determine a value of the first weight coefficient based on the value of the second weight coefficient, wherein the value of the second weight coefficient is positively correlated with the number of iterations; and

a third adjusting subunit, configured to, in response to the number of iterations of model training being greater than the second threshold, adjust both the first weight coefficient and the second weight coefficient to a third value.

In some embodiments, the second adjusting unit is configured to, in response to the number of iterations of model training being greater than the first threshold and less than or equal to the second threshold, determine the value of the second weight coefficient based on the number of iterations and linear relationship data, wherein the linear relationship data is relationship data in which the value of the second weight coefficient linearly increases with the number of iterations.

In some embodiments, the model determining unit 702 is further configured to determine the second association model corresponding to the first multimedia recommendation model based on the first association model corresponding to the first multimedia recommendation model at an interval of a target number of iterations and upon completion of the current iteration.

In some embodiments, the apparatus further includes:

a receiving unit, configured to receive online data from a terminal, and iteratively train the plurality of multimedia recommendation models based on the online data.

The model determining unit 702 is further configured to determine the association model corresponding to the first multimedia recommendation model at an interval of a target period and upon completion of the current iteration.

In the technical solution according to the embodiments of the present disclosure, the association model determined for each multimedia recommendation model every time is determined based on the association model determined last time. Therefore, the model parameters of the various multimedia recommendation models can be combined and interacted as much as possible, parameter optimization among the multimedia recommendation models can be performed more extensively, and the comprehensiveness of model training is improved, which improves a prediction capability of the multimedia recommendation model.

FIG. 8 is a block diagram of a server according to an exemplary embodiment of the present disclosure. The server 800 may vary greatly depending on different configurations or performances. In some embodiments, the server 800 includes one or more central processing units (CPUs) 801 and one or more memories 802. At least one program code is stored in the one or more memories 802. The at least one program code, when loaded and executed by the one or more processors 801, causes the one or more processors 801 to perform:

iteratively training a plurality of multimedia recommendation models, wherein model structures of the plurality of multimedia recommendation models are the same, and a model parameter of each of the plurality of multimedia recommendation models is a weight parameter;

determining, based on a first association model corresponding to a first multimedia recommendation model, a second association model corresponding to the first multimedia recommendation model, wherein the first association model is an association model determined at an i^{th} model determination, and the second association model is an association model determined at a (i+1)^{th} model determination, where i is a positive integer, the first multimedia recommendation model is any one of the plurality of multimedia recommendation models, each of the first association model and the second association model is one of the plurality of multimedia recommendation models excluding the first multimedia recommendation model, and the first association model is different from the second association model; and

determining, based on the model parameter of the first multimedia recommendation model and the model parameter of the second association model, a target model parameter of the first multimedia recommendation model.

In some embodiments, the at least one program code, when loaded and executed by the one or more processors 801, causes the one or more processors 801 to perform:

selecting, upon a completion of an iteration, an initial association model of the first multimedia recommendation model from the plurality of multimedia recommendation models excluding the first multimedia recommendation model, wherein each of the plurality of multimedia recommendation models is corresponding to a different initial association model; and

determining, upon completion of a N^{th} iteration, a next multimedia recommendation model adjacent to the first association model, as the second association model corresponding to the first multimedia recommendation model, where N is a number of iterations of model training, and N is a positive integer greater than 1.

In some embodiments, the at least one program code, when loaded and executed by the one or more processors 801, causes the one or more processors 801 to perform:

in response to K−1 association models of the first multimedia recommendation model having been determined, selecting the initial association model of the first multimedia recommendation model as the association model of the first multimedia recommendation model upon completion of a current iteration; wherein K is a number of the plurality of multimedia recommendation models, and K is a positive integer greater than 1.

In some embodiments, the at least one program code, when loaded and executed by the one or more processors 801, causes the one or more processors 801 to perform:

determining the target model parameter of the first multimedia recommendation model by determining a weighted average of the model parameter of the first multimedia recommendation model and the model parameter of the second association model based on a first weight coefficient of the first multimedia recommendation model and a second weight coefficient of the second association model.

In some embodiments, the at least one program code, when loaded and executed by the one or more processors 801, causes the one or more processors 801 to perform:

determining, based on a number of iterations of model training, the first weight coefficient and the second weight coefficient.

In some embodiments, the at least one program code, when loaded and executed by the one or more processors 801, causes the one or more processors 801 to perform:

in response to the number of iterations of model training being less than or equal to a first threshold, adjusting the first weight coefficient to a first value, and adjusting the second weight coefficient to a second value, wherein the first value is greater than the second value;

in response to the number of iterations of model training being greater than the first threshold and less than or equal to a second threshold, determining a value of the second weight coefficient based on the number of iterations, and determining a value of the first weight coefficient based on the value of the second weight coefficient, wherein the value of the second weight coefficient is positively correlated with the number of iterations; or

in response to the number of iterations of model training being greater than the second threshold, adjusting both the first weight coefficient and the second weight coefficient to a third value.

In some embodiments, the at least one program code, when loaded and executed by the one or more processors 801, causes the one or more processors 801 to perform:

in response to the number of iterations of model training being greater than the first threshold and less than or equal to the second threshold, determining the value of the second weight coefficient based on the number of iterations and linear relationship data, wherein the linear relationship data is relationship data in which the value of the second weight coefficient linearly increases with the number of iterations.

In some embodiments, the at least one program code, when loaded and executed by the one or more processors 801, causes the one or more processors 801 to perform:

determining the second association model corresponding to the first multimedia recommendation model based on the first association model corresponding to the first multimedia recommendation model at an interval of a target number of iterations and upon completion of the current iteration.

In some embodiments, the at least one program code, when loaded and executed by the one or more processors 801, causes the one or more processors 801 to perform:

receiving online data from a terminal, and iteratively training the plurality of multimedia recommendation models based on the online data.

In some other embodiments, the server 800 also has a component such as a wired or wireless network interface, a keyboard, and an input and output interface for input and output. The server 800 also includes other components for implementing device functions, which are not repeated here.

In an exemplary embodiment, a non-transitory computer-readable storage medium including at least one program code, for example, a memory 802 including the program code, is further provided. The at least one program code, when loaded and executed by a processor 801 of a server 800, causes the server 800 to perform:

iteratively training a plurality of multimedia recommendation models, wherein model structures of the plurality of multimedia recommendation models are the same, and a model parameter of each of the plurality of multimedia recommendation models is a weight parameter;

determining, based on a first association model corresponding to a first multimedia recommendation model, a second association model corresponding to the first multimedia recommendation model, wherein the first association model is an association model determined at an i^{th} model determination, and the second association model is an association model determined at a (i+1)^{th} model determination, where i is a positive integer, the first multimedia recommendation model is any one of the plurality of multimedia recommendation models, each of the first association model and the second association model is one of the plurality of multimedia recommendation models excluding the first multimedia recommendation model, and the first association model is different from the second association model; and

determining, based on the model parameter of the first multimedia recommendation model and the model parameter of the second association model, a target model parameter of the first multimedia recommendation model.

In some embodiments, the at least one program code, when loaded and executed by the processor 801 of the server 800, causes the server 800 to perform:

selecting, upon a completion of an iteration, an initial association model of the first multimedia recommendation model from the plurality of multimedia recommendation models excluding the first multimedia recommendation model, wherein each of the plurality of multimedia recommendation models is corresponding to a different initial association model; and

determining, upon completion of a N^{th} iteration, a next multimedia recommendation model adjacent to the first association model, as the second association model corresponding to the first multimedia recommendation model, where N is a number of iterations of model training, and N is a positive integer greater than 1.

In some embodiments, the at least one program code, when loaded and executed by the processor 801 of the server 800, causes the server 800 to perform:

in response to K-1 association models of the first multimedia recommendation model having been determined, selecting the initial association model of the first multimedia recommendation model as the association model of the first multimedia recommendation model upon completion of a current iteration; wherein K is a number of the plurality of multimedia recommendation models, and K is a positive integer greater than 1.

In some embodiments, the at least one program code, when loaded and executed by the processor 801 of the server 800, causes the server 800 to perform:

determining the target model parameter of the first multimedia recommendation model by determining a weighted average of the model parameter of the first multimedia recommendation model and the model parameter of the second association model based on a first weight coefficient of the first multimedia recommendation model and a second weight coefficient of the second association model.

In some embodiments, the at least one program code, when loaded and executed by the processor 801 of the server 800, causes the server 800 to perform:

determining, based on a number of iterations of model training, the first weight coefficient and the second weight coefficient.

In some embodiments, the at least one program code, when loaded and executed by the processor 801 of the server 800, causes the server 800 to perform:

in response to the number of iterations of model training being less than or equal to a first threshold, adjusting the first weight coefficient to a first value, and adjusting the second weight coefficient to a second value, wherein the first value is greater than the second value;

in response to the number of iterations of model training being greater than the first threshold and less than or equal to a second threshold, determining a value of the second weight coefficient based on the number of iterations, and determining a value of the first weight coefficient based on the value of the second weight coefficient, wherein the value of the second weight coefficient is positively correlated with the number of iterations; or

in response to the number of iterations of model training being greater than the second threshold, adjusting both the first weight coefficient and the second weight coefficient to a third value.

In some embodiments, the at least one program code, when loaded and executed by the processor 801 of the server 800, causes the server 800 to perform:

in response to the number of iterations of model training being greater than the first threshold and less than or equal to the second threshold, determining the value of the second weight coefficient based on the number of iterations and linear relationship data, wherein the linear relationship data is relationship data in which the value of the second weight coefficient linearly increases with the number of iterations.

In some embodiments, the at least one program code, when loaded and executed by the processor 801 of the server 800, causes the server 800 to perform:

determining the second association model corresponding to the first multimedia recommendation model based on the first association model corresponding to the first multimedia recommendation model at an interval of a target number of iterations and upon completion of the current iteration.

In some embodiments, the at least one program code, when loaded and executed by the processor 801 of the server $00, causes the server 800 to perform:

receiving online data from a terminal, and iteratively training the plurality of multimedia recommendation models based on the online data.

In some embodiments, the computer-readable storage medium is a non-transitory computer-readable storage medium. For example, the non-transitory computer-readable storage medium may be a read-only memory (ROM), a random-access memory (RAM), a compact disc read-only memory (CD-ROM), a magnetic disk, a floppy disk, an optical data storage device, etc.

All the embodiments of the present disclosure can be executed individually or in combination with other embodiments, and they are all regarded as the scope of protection claimed by the present disclosure.

What is claimed is:

1. A method for training a multimedia recommendation model, applicable to a server, the method comprising:
iteratively training a plurality of multimedia recommendation models, wherein model structures of the plurality of multimedia recommendation models are the same, and a model parameter of each of the plurality of multimedia recommendation models is a weight parameter;
determining, based on a first association model corresponding to a first multimedia recommendation model, a second association model corresponding to the first multimedia recommendation model, wherein the first association model is an association model determined at an i^{th} model determination, and the second association model is an association model determined at a (i+1)^{th} model determination, where i is a positive integer, the first multimedia recommendation model is any one of the plurality of multimedia recommendation models, each of the first association model and the second association model is one of the plurality of multimedia recommendation models excluding the first multimedia recommendation model, and the first association model is different from the second association model; and
determining, based on the model parameter of the first multimedia recommendation model and the model parameter of the second association model, a target model parameter of the first multimedia recommendation model.

2. The method according to claim 1, wherein said determining, based on the first association model corresponding to the first multimedia recommendation model, the second association model corresponding to the first multimedia recommendation model comprises:
selecting, upon a completion of an iteration, an initial association model of the first multimedia recommendation model from the plurality of multimedia recommendation models excluding the first multimedia recommendation model, wherein each of the plurality of multimedia recommendation models is corresponding to a different initial association model; and
determining, upon completion of a N^{th} iteration, a next multimedia recommendation model adjacent to the first association model, as the second association model corresponding to the first multimedia recommendation model, where N is a number of iterations of model training, and N is a positive integer greater than 1.

3. The method according to claim 2, further comprising:
in response to K−1 association models of the first multimedia recommendation model having been determined, selecting the initial association model of the first multimedia recommendation model as the association model of the first multimedia recommendation model upon completion of a current iteration; wherein K is a number of the plurality of multimedia recommendation models, and K is a positive integer greater than 1.

4. The method according to claim 1, wherein said determining, based on the model parameter of the first multimedia recommendation model and the model parameter of the second association model, the target model parameter of the first multimedia recommendation model comprises:
determining the target model parameter of the first multimedia recommendation model by determining a weighted average of the model parameter of the first multimedia recommendation model and the model parameter of the second association model based on a first weight coefficient of the first multimedia recommendation model and a second weight coefficient of the second association model.

5. The method according to claim 4, further comprising:
determining, based on a number of iterations of model training, the first weight coefficient and the second weight coefficient.

6. The method according to claim 5, wherein said determining, based on the number of iterations of model training, the first weight coefficient and the second weight coefficient comprises:
in response to the number of iterations of model training being less than or equal to a first threshold, adjusting the first weight coefficient to a first value, and adjusting the second weight coefficient to a second value, wherein the first value is greater than the second value;
in response to the number of iterations of model training being greater than the first threshold and less than or equal to a second threshold, determining a value of the second weight coefficient based on the number of iterations, and determining a value of the first weight coefficient based on the value of the second weight coefficient, wherein the value of the second weight coefficient is positively correlated with the number of iterations; or
in response to the number of iterations of model training being greater than the second threshold, adjusting both the first weight coefficient and the second weight coefficient to a third value.

7. The method according to claim 6, wherein said determining, in response to the number of iterations of model training being greater than the first threshold and less than or equal to the second threshold, the value of the second weight coefficient based on the number of iterations comprises:
in response to the number of iterations of model training being greater than the first threshold and less than or equal to the second threshold, determining the value of the second weight coefficient based on the number of iterations and linear relationship data, wherein the linear relationship data is relationship data in which the value of the second weight coefficient linearly increases with the number of iterations.

8. The method according to claim 1, wherein said determining, based on the first association model corresponding to the first multimedia recommendation model, the second association model corresponding to the first multimedia recommendation model comprises:
determining the second association model corresponding to the first multimedia recommendation model based on the first association model corresponding to the first multimedia recommendation model at an interval of a target number of iterations and upon completion of a current iteration.

9. The method according to claim 1, wherein said iteratively training the plurality of multimedia recommendation models comprises:
receiving online data from a terminal, and iteratively training the plurality of multimedia recommendation models based on the online data.

10. A server, comprising:
one or more processors; and
a memory configured to store at least one program code executable by the one or more processors;
wherein the one or more processors, when loading and executing the at least one program code, are caused to perform:
iteratively training a plurality of multimedia recommendation models, wherein model structures of the plurality of multimedia recommendation models are the same, and a model parameter of each of the plurality of multimedia recommendation models is a weight parameter;
determining, based on a first association model corresponding to a first multimedia recommendation model, a second association model corresponding to the first multimedia recommendation model, wherein the first association model is an association model determined at an i^{th} model determination, and the second association model is an association model determined at a (i+1)^{th} model determination, where i is a positive integer, the first multimedia recommendation model is any one of the plurality of multimedia recommendation models, each of the first association model and the second association model is one of the plurality of multimedia recommendation models excluding the first multimedia recommendation model, and the first association model is different from the second association model; and
determining, based on the model parameter of the first multimedia recommendation model and the model parameter of the second association model, a target model parameter of the first multimedia recommendation model.

11. The server according to claim 10, wherein the one or more processors, when loading and executing the at least one program code, are caused to perform:
selecting, upon a completion of an iteration, an initial association model of the first multimedia recommendation model from the plurality of multimedia recommendation models excluding the first multimedia recommendation model, wherein each of the plurality of multimedia recommendation models is corresponding to a different initial association model; and
determining, upon completion of a N^{th} iteration, a next multimedia recommendation model adjacent to the first association model, as the second association model corresponding to the first multimedia recommendation model, where N is a number of iterations of model training, and N is a positive integer greater than 1.

12. The server according to claim 11, wherein the one or more processors, when loading and executing the at least one program code, are caused to perform:
in response to K−1 association models of the first multimedia recommendation model having been determined, selecting the initial association model of the first multimedia recommendation model as the association model of the first multimedia recommendation model upon completion of a current iteration; wherein K is a number of the plurality of multimedia recommendation models, and K is a positive integer greater than 1.

13. The server according to claim 10, wherein the one or more processors, when loading and executing the at least one program code, are caused to perform:
determining the target model parameter of the first multimedia recommendation model by determining a weighted average of the model parameter of the first multimedia recommendation model and the model parameter of the second association model based on a first weight coefficient of the first multimedia recommendation model and a second weight coefficient of the second association model.

14. The server according to claim 13, wherein the one or more processors, when loading and executing the at least one program code, are caused to perform:
determining, based on a number of iterations of model training, the first weight coefficient and the second weight coefficient.

15. The server according to claim 14, wherein the one or more processors, when loading and executing the at least one program code, are caused to perform:
in response to the number of iterations of model training being less than or equal to a first threshold, adjusting the first weight coefficient to a first value, and adjusting the second weight coefficient to a second value, wherein the first value is greater than the second value;
in response to the number of iterations of model training being greater than the first threshold and less than or equal to a second threshold, determining a value of the second weight coefficient based on the number of iterations, and determining a value of the first weight coefficient based on the value of the second weight coefficient, wherein the value of the second weight coefficient is positively correlated with the number of iterations; or
in response to the number of iterations of model training being greater than the second threshold, adjusting both the first weight coefficient and the second weight coefficient to a third value.

16. The server according to claim 15, wherein the one or more processors, when loading and executing the at least one program code, are caused to perform:
in response to the number of iterations of model training being greater than the first threshold and less than or equal to the second threshold, determining the value of the second weight coefficient based on the number of iterations and linear relationship data, wherein the linear relationship data is relationship data in which the value of the second weight coefficient linearly increases with the number of iterations.

17. The server according to claim 10, wherein the one or more processors, when loading and executing the at least one program code, are caused to perform:
determining the second association model corresponding to the first multimedia recommendation model based on the first association model corresponding to the first multimedia recommendation model at an interval of a target number of iterations and upon completion of a current iteration.

18. The server according to claim 10, wherein the one or more processors, when loading and executing the at least one program code, are caused to perform:
receiving online data from a terminal, and iteratively training the plurality of multimedia recommendation models based on the online data.

19. A non-transitory computer-readable storage medium storing at least one program code, wherein the at least one program code, when loaded and executed by a processor of a server, causes the server to perform:
iteratively training a plurality of multimedia recommendation models, wherein model structures of the plurality of multimedia recommendation models are the same, and a model parameter of each of the plurality of multimedia recommendation models is a weight parameter;
determining, based on a first association model corresponding to a first multimedia recommendation model, a second association model corresponding to the first multimedia recommendation model, wherein the first association model is an association model determined at an i^{th} model determination, and the second association model is an association model determined at a (i+1)^{th} model determination, where i is a positive integer, the first multimedia recommendation model is any one of the plurality of multimedia recommendation models, each of the first association model and the second association model is one of the plurality of multimedia recommendation models excluding the first multimedia recommendation model, and the first association model is different from the second association model; and
determining, based on the model parameter of the first multimedia recommendation model and the model parameter of the second association model, a target model parameter of the first multimedia recommendation model.

20. The non-transitory computer-readable storage medium according to claim 19, wherein the at least one program code, when loaded and executed by a processor of a server, causes the server to perform:
selecting, upon a completion of an iteration, an initial association model of the first multimedia recommendation model from the plurality of multimedia recommendation models excluding the first multimedia recommendation model, wherein each of the plurality of multimedia recommendation models is corresponding to a different initial association model; and
determining, upon completion of a N^{th} iteration, a next multimedia recommendation model adjacent to the first association model, as the second association model corresponding to the first multimedia recommendation model, where N is a number of iterations of model training, and N is a positive integer greater than 1.
